(19) United States
(12) Patent Application Publication
(10) Pub. No.: US 2009/0257852 A1
(43) Pub. Date: Oct. 15, 2009

(54) Articulated Aircraft Loader

(75) Inventor: Antoine Maguin, Samois-Sur-Seine (FR)

Correspondence Address: KNOBBE MARTENS OLSON & BEAR LLP, 2040 MAIN STREET, FOURTEENTH FLOOR, IRVINE, CA, 92614, US

(73) Assignee: TLD (CANADA) INC., Sherbrooke, QC (CA)

(21) Appl. No.: 11/721,665

(22) PCT Filed: Dec. 15, 2005
(86) PCT No.: PCT/CA2005/001906

§ 371 Date: Jun. 13, 2007

Related U.S. Application Data
(60) Provisional application No. 60/635,948, filed on Dec. 15, 2004.

(51) Int. Cl. B60P 1/02

(52) U.S. Cl. 414/339

(57) ABSTRACT

The invention provides an articulated aircraft loader for loading and unloading goods in and out of an aircraft. The articulated aircraft loader is provided with a main chassis having a main loading platform mounted thereon. The main loading platform is moveable between a lower elevation level and an upper elevation level substantially coplanar with the loading level of the aircraft. The articulated aircraft loader also has a rear chassis connectable to the main chassis and provided with a rear loading platform moveable between a lowermost elevation level and a second elevation level comprised between the lower and upper elevation levels for allowing transfer of goods between the main and rear platforms. The articulated aircraft loader also has articulated connecting means operatively connected to each of the main chassis for articularly connecting the rear chassis to the main chassis. The articulated aircraft loader is also provided with straightening means operatively connected to the rear chassis for straightening the rear chassis in longitudinal alignment with the main chassis. The present aircraft loader advantageously allows to reach lower, main and upper decks of an aircraft while being compact and maneuverable thanks to its articulated design.

### FIELD OF THE INVENTION

The present invention generally relates to an aircraft loader for transferring cargo and freight to and from an aircraft cargo bay. The invention more particularly concerns an articulated aircraft loader particularly adapted to aircrafts having lower, main and upper decks while being particularly effective and easy to use.

### BACKGROUND OF THE INVENTION

Loaders are used for aircraft servicing, and are designed to transfer containers, pallets, luggages and other types of goods to the aircraft. Many of the existing loaders have an elevator platform, a bridge platform for interfacing the elevator platform to the aircraft cargo bay, and a control station for controlling operation of the loader.

French patent No. 2.031.709 and U.S. Pat. Nos. 3,993,207 and 4,304,518 provide examples of loaders known in the art.

Most of the aircraft currently in use, such as Boeing, Airbus, etc., have lower and main decks and therefore only LDLs (lower deck loader) and MDLs (main deck loader) are used. However, both of these loaders are not designed for new types of aircrafts, such as the A380® from Airbus® for example, since such aircrafts are provided with lower, main and upper decks. Indeed, LDLs and MDLs cannot reach the upper deck of such aircrafts and UDLs (upper deck loader) are thus required.

Known in the art, there is US patent application No. 2004/0115034 which describes an apparatus and a method for loading and unloading an aircraft provided with an upper deck. The disclosed apparatus has a first loader provided with a loading platform movable between an uppermost position disposed substantially coplanar with the load level of the aircraft, and a lowermost position disposed substantially coplanar with the load level of a raised loading platform of a second loader. The first loader thus forms an adapter between the aircraft and the second loader. The first loader is also provided with a transfer bridge adjacent to the loading platform and capable of being docked adjacent the aircraft.

The service operations which can be done with such an apparatus are limited by its bulky design. Indeed, two distinct loaders are required and have to be operated separately. Thus, the first loader has to be dock to the aircraft, and, then, the second loader has to be precisely positioned with respect to the first loader. This complicates the operations which have to be made and the control of the apparatus itself is also complicated.

Moreover, in the proposed design, the control station is located on the loading platform of the first loader. Thus, the operator has a poor vision of various parts of the loaders and of the load level of the aircraft, especially when the loading platform is lowered. Two operators will thus generally be required to operate the apparatus in a more safety manner, the first one being on the loading platform while the second one is on ground. However, none of the operators has a good vision of the load level of the aircraft. This could be problematic since goods can fall down of the aircraft when the loading platform is lowered and hurt the operator placed thereon.

Also of interest, there is PCT application of the same Applicant, published under publication number WO2004/096642, which describes an aircraft loader having a configuration allowing to meet full loading cycle requirements imposed by airlines while leaving a good vision of the loader parts to the operator during cargo operation since the control station is mounted on the bridge platform. However, even if safety of the loader operator is improved, safety issues of others operators working inside the aircraft still remains since they are not protected from falling down of the aircraft bay. Moreover, its cumbersome design decreases the operator visibility when driving.

Furthermore, even if this aircraft loader has proved to be very efficient, manoeuvrability and transportability of such bulky aircraft loaders remain important issues. Such aircraft loaders are also expensive to manufacture.

Also of interest, there are U.S. Pat. No. 4,799,848; European patent applications Nos. 0 698 525 and 1 277 681; and PCT application No. PCT/GB90/00937.

Even if the art provides aircraft loaders adapted to reach the upper deck of an aircraft, none of the above-described documents provide an aircraft loader which meets full loading cycle requirements imposed by airlines while providing an easy and effective use thereof.

It would therefore be desirable to provide an aircraft loader adapted to transfer goods to and from lower, main and upper decks of an aircraft in an easier and more effective manner, while meeting full loading cycle requirements imposed by airlines.

### SUMMARY

An object of the present invention is to provide an aircraft loader that satisfies the above-mentioned needs.

Accordingly, the present invention provides an articulated aircraft loader for loading and unloading goods in and out of an aircraft having a loading level. The articulated aircraft loader is provided with a main chassis having a front end opposite a rear end. The main chassis is provided with a main loading platform mounted thereon. The main loading platform is moveable between a lower elevation level and an upper elevation level substantially coplanar with the loading level of the aircraft. The articulated aircraft loader also has a rear chassis connectable to the main chassis. The rear chassis has a front end opposite a rear end. The rear chassis is provided with a rear loading platform moveable between a lowermost elevation level and a second elevation level comprised between the lower and upper elevation levels for allowing transfer of goods between the main and rear platforms when the platforms extend at a same level. The articulated aircraft loader also has articulated connecting means operatively connected to each of the main chassis and the rear chassis for articularly connecting the rear chassis to the main chassis. The articulated aircraft loader is also provided with straightening means operatively connected to the rear chassis for straightening the rear chassis in longitudinal alignment with the main chassis.

Advantageously, the aircraft loader of the present invention allows to reach lower, main and upper decks of an aircraft while allowing to meet full loading cycle requirements imposed by airlines in an effective manner.

Moreover, thanks to its articulated design, the aircraft loader is advantageously compact and manoeuvrable.

### BRIEF DESCRIPTION OF THE DRAWINGS

These and other objects and advantages of the invention will become apparent upon reading the detailed description and upon referring to the drawings in which:

FIG. 1 is a perspective side view of an aircraft loader according to the present invention, the aircraft loader being provided with an additional platform.

FIG. 2 is a perspective front view of the aircraft loader of FIG. 1.

FIG. 3 is a perspective top view of the aircraft loader of FIG. 1.

FIG. 4A is a side view of the aircraft loader shown in FIG. 1.

FIG. 4B is a top view of the aircraft loader shown in FIG. 1.

FIG. 4C is a front view of the aircraft loader shown in FIG. 1.

FIG. 5A is a side view of the aircraft loader of FIG. 1.

FIG. 5B is a top view of the aircraft loader of FIG. 1.

FIG. 5C is a front view of the aircraft loader of FIG. 1.

FIG. 6 is another perspective side view of an aircraft loader according to the present invention, the aircraft loader being provided with another additional platform.

FIG. 7 is another perspective front view of the aircraft loader of FIG. 1, the loading platform being shown in three different positions.

FIG. 8 is another perspective front view of the aircraft loader of FIG. 1, the loading platform being shown in the upper position.

FIG. 9 is a perspective rear view of the aircraft loader of FIG. 1, the bridge platform being docked to the main deck of the aircraft.

FIG. 10 is another perspective rear view of the aircraft loader of FIG. 1, the bridge platform being docked to the upper deck of the aircraft.

FIG. 11 is another perspective rear view of the aircraft loader of FIG. 1.

FIG. 12 is another perspective rear view of the aircraft loader of FIG. 1.

FIG. 13A is a perspective rear view of the loading platform and the bridge platform of the aircraft loader of FIG. 1, the bridge platform being docked to a deck of the aircraft.

FIG. 13B is another perspective rear view of the loading platform and the bridge platform shown in FIG. 1, the bridge platform being docked to a deck of the aircraft.

FIG. 14 is a partial perspective front view of the bridge platform of the aircraft loader shown in FIG. 1, the bridge platform being docked to a deck of the aircraft.

FIG. 15 is another perspective rear view of the loading platform and the bridge platform, the handrails extending in a retracted position.

FIGS. 16A and 16B show the aircraft device of FIG. 1 and the additional platform in a dismantled position.

FIGS. 16C and 16D show the aircraft device of FIG. 1 in a dismantled position.

FIGS. 17A and 17B show the aircraft device of FIG. 1 and the additional platform in a dismantled position for transportation in an aircraft.

FIGS. 17C and 17D show the aircraft device of FIG. 1 in a dismantled position for transportation in an aircraft.

FIG. 18 is a perspective view of a bridge platform of an aircraft loader according to the present invention.

FIG. 19A shows retractable handrails according to a preferred embodiment of the present invention, the handrails extending in the extended position.

FIG. 19B shows the retractable handrails of FIG. 19A, the handrails extending in an intermediate position.

FIG. 19C shows the retractable handrails of FIG. 19A, the handrails extending in the retracted position.

FIG. 20 is a bottom view of an articulated aircraft loader according to a preferred embodiment of the present invention.

FIG. 21 is a partial view of the articulated aircraft loader shown in FIG. 20.

While the invention will be described in conjunction with example embodiments, it will be understood that it is not intended to limit the scope of the invention to such embodiments. On the contrary, it is intended to cover all alternatives, modifications and equivalents as may be included as defined by the appended claims.

### DESCRIPTION OF THE PREFERRED EMBODIMENTS

In the following description, similar features in the drawings have been given similar reference numerals and in order to lighten the figures, some elements are not referred to in some figures if they were already identified in a precedent figure.

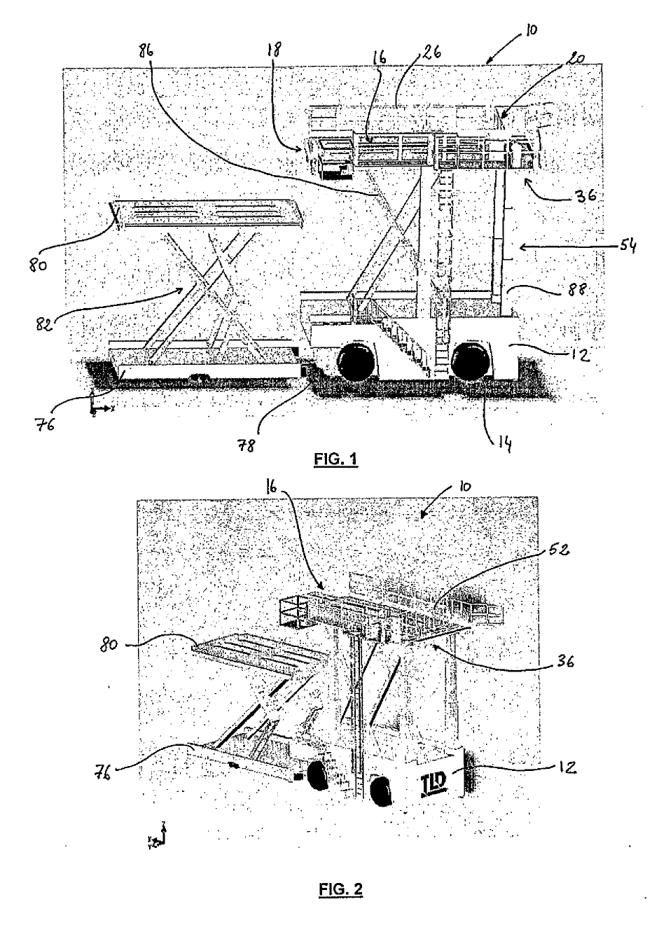

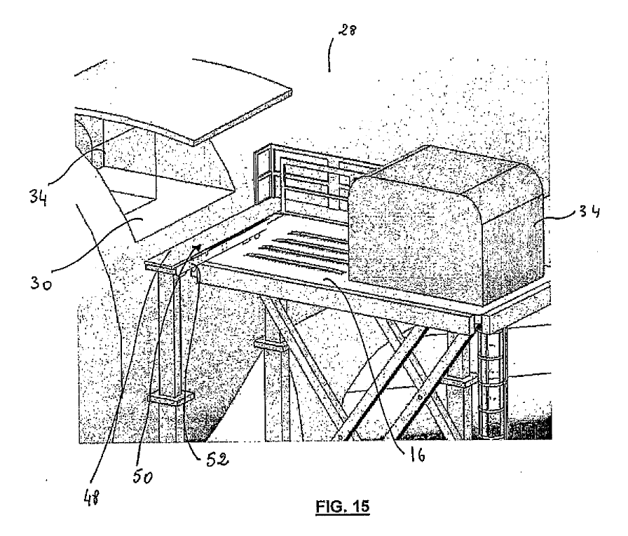

Referring to FIGS. 1 to 5C and 9, there is shown an aircraft loader 10 for loading and unloading goods (not shown) in and out of an aircraft 28 having a loading level 30. The loading level 30 can advantageously be the lower, the main or the upper deck of the aircraft 28. Thus, it is important to note that the present loader 10 can advantageously be used with any types of aircraft, including newer big aircrafts such as the A380® from Airbus® for a non-limitative example. The aircraft loader 10 is provided with a main chassis 12, advantageously having wheels 14 for displacement of the loader 10 on the tarmac 32. Preferably, the aircraft loader 10 has lowerable stabilizing legs (not shown) projecting under the main chassis 12 for stabilizing the loader 10 when in use. The aircraft loader 10 is also provided with a loading platform 16 mounted on the chassis 12 and moveable between a lower elevation level and an upper elevation level substantially coplanar with the loading level 30 of the aircraft 28. Preferably, the upper elevation level extends at the level of the upper deck of the aircraft 28 for allowing loading thereof. However, it could also be envisaged to use the present aircraft loader 10 to load aircrafts having only lower and main deck. The loading platform 16 has a loading end 18 opposite an unloading end 20 and two side edges 22, 24. Preferably, the loading platform 16 is provided with side handrails 26 extending on each side thereof. Goods generally include containers of a predetermined size. Thus, preferably, as illustrated on FIG. 15, the loading platform 16 has a length adapted to provide support for two containers 34 which are transferred in line on the loading platform 16, one after the other, thereby allowing to meet full loading cycle requirements imposed by airlines.

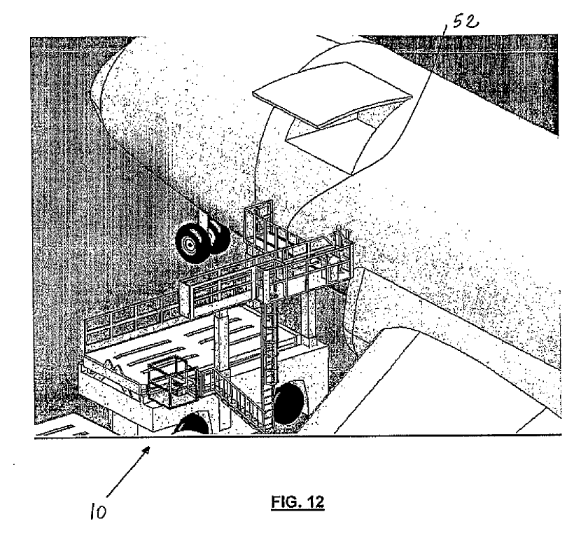

Still referring to FIGS. 1 to 5C and 9, the aircraft loader 10 is also provided with an interface device 36 mounted on the chassis 12 for interfacing the unloading end 20 of the loading platform 16 with the loading level 28 of the aircraft 30. The interface device 36 has a bridge platform 38 moveable between a base elevation level and the upper elevation level. The bridge platform 38 has a loading end 40 opposite an unloading end 42 and two side edges 44, 46. The bridge platform 38 further has a transfer portion 48 extending between the ends 40, 42 thereof. The loading end 40 of the bridge platform 38 extends in adjacent alignment along the unloading end 20 of the loading platform 16 when both platforms 16, 38 extend at the upper level for providing a goods path 50 between the loading platform 16 and the loading level 30 of the aircraft 28 through the transfer portion 48, as better illustrated on FIG. 15. Thus, referring now also to FIG. 15, when both platforms 16, 38 extends at the aircraft loading level 30, goods are allowed to move from the loading platform 16 to the aircraft loading level 30 through the transfer portion 48. The interface device 36 also has retractable handrails 52 mounted along a respective one of the ends 40, 42 of the bridge platform 38. As better shown on FIG. 12, the retractable handrails 52 have an extended position wherein the handrails 52 are raised above the upper elevation level across the goods path 50 for blocking passage of the goods between the loading level 30 of the aircraft 28 and the loading platform 16. The retractable handrails 52 also have a retracted position wherein the handrails 52 are moved away from the goods path 50 when both platforms 16, 38 extend at the upper elevation level for allowing passage of the goods between the loading level 30 of the aircraft 28 and the loading platform 16, as better shown on FIG. 15.

Still referring to FIGS. 1 to 5C the aircraft loader 10 is also provided with a lifting device 54 for raising and lowering each of the loading platform 16 and the bridge platform 38 between their respective elevation levels, as it will be more detailed thereinafter. The aircraft loader 10 also has control means for controlling operation of the lifting device.

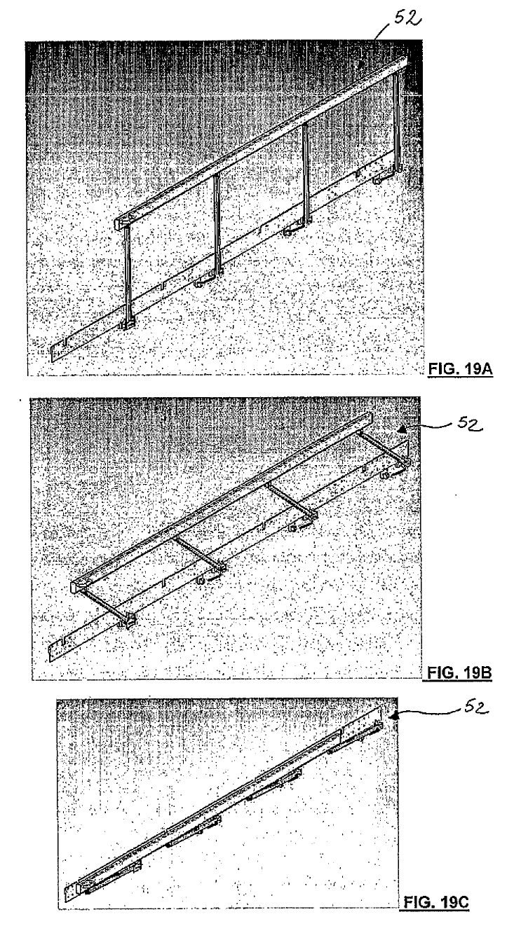

Referring now to FIGS. 19A to 19C, in a preferred embodiment, the interface device 36 further advantageously comprises a handrails retracting mechanism (not shown) operatively connected to the retractable handrails 52 for operating the handrails 52 between each of the extended and retracted positions. FIG. 19A shows the handrails 52 in the extended position, FIG. 19C shows the handrails 52 in the retracted position while FIG. 19B shows an intermediate position of the handrails 52. Preferably, the handrails retracting mechanism is responsive to a movement of the loading platform 16. Indeed, when the loading platform 16 moves close to the bridge platform 38, the handrails retracting mechanism is activated to operate the handrails 52 accordingly. In the illustrated case, the handrails 52 vertically fold on itself. However, it should be noted that any convenient means for moving the handrails 52 away of the goods path 50 could be envisaged. For example, the handrails retracting mechanism may comprise a weight-and-pulley device for vertically lowering the handrails 52 below the upper elevation level when each of the platforms 16, 38 extends at the upper elevation level. Alternatively, the handrails retracting mechanism may be provided with a pivot device for pivoting the handrails below the upper elevation level when each of the platforms 16, 38 extends at the upper elevation level.

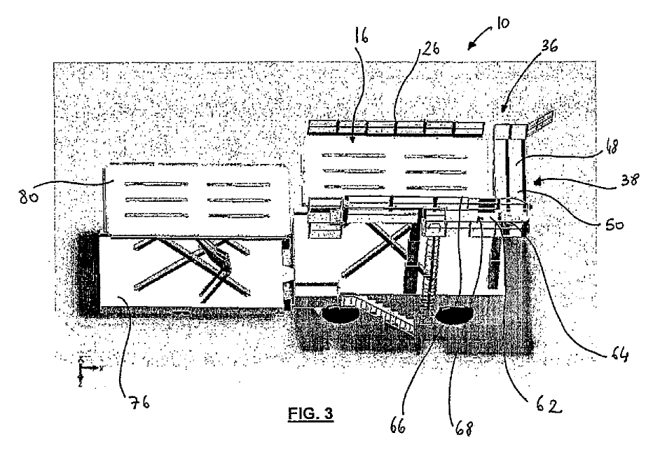

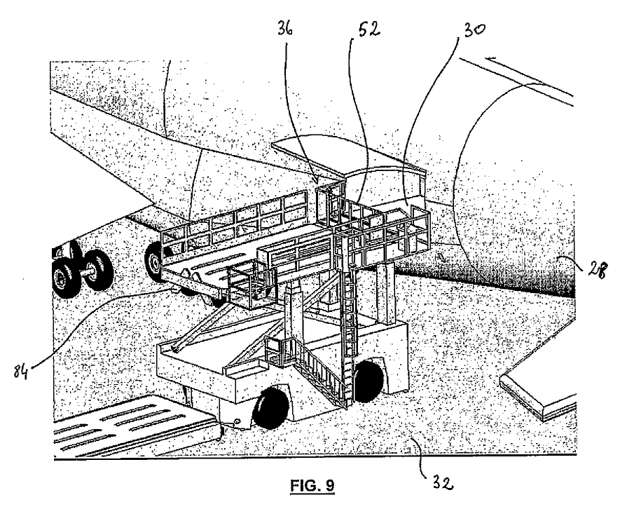

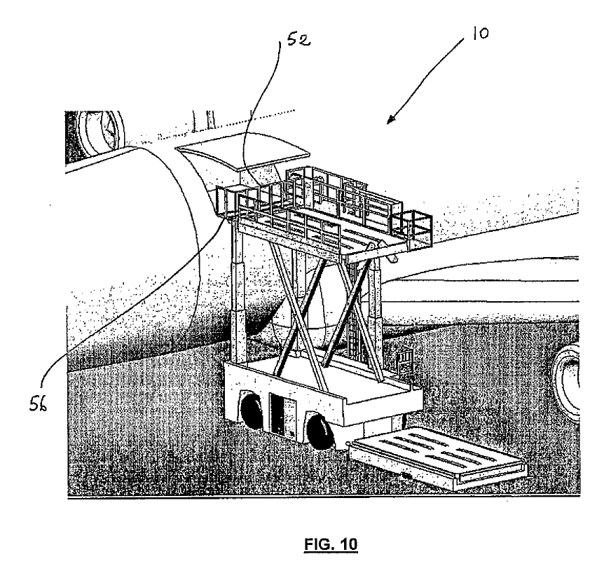

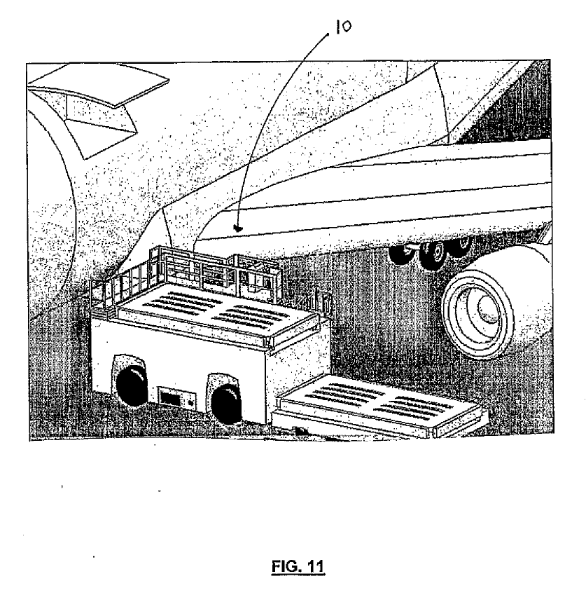

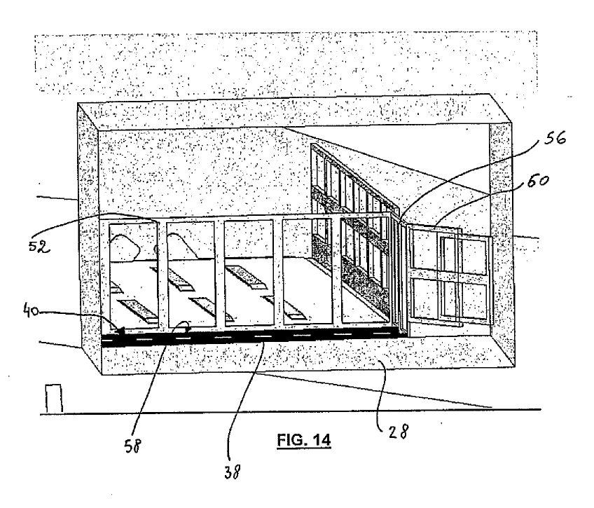

Referring again to FIGS. 9 and 10 and also to FIG. 14, preferably, the retractable handrails 52 are mounted along the loading end 40 of the bridge platform 38, as it can be better seen on FIG. 3. More preferably, the bridge platform 38 has side handrails 56 extending on each side thereof. Thus, the retractable handrails 52 and the side handrails 56 define a protected working cell 58 around the bridge platform 38 that prevents operators working inside the aircraft 28 failing down of the aircraft 28 when the loading platform 16 is lowered.

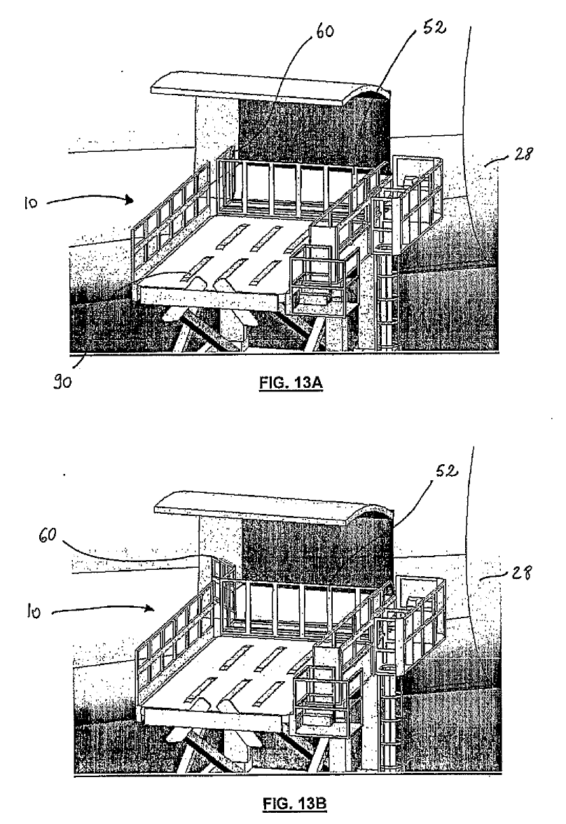

This protected working cell 58 also allows to prevent goods from falling down of the aircraft 28 when the loading platform 16 is lowered, thereby also enhancing safety of the loader operator which is then protected against unwanted movements of goods. With this particular embodiment, there is advantageously no man's land area on both platforms 16, 38. Even more preferably, referring now also to FIGS. 13A and 13B, in order to provide an aircraft loader 10 particularly adapted to any particular aircraft which can have bays of different wide, the bridge platform 38 is further provided with a retractable door extension 60 extending on a respective one of the side edges 44, 46 of the bridge platform 38. With this particular embodiment, the protected working cell 58 can be entirely closed for improving safety of the operators. Preferably, the retractable door extension 60 is pivotally mounted to the respective side edge 44, 46 of the bridge platform 38 even if other arrangement could also be envisaged. In order to provide a more convenient door extension 60, one could also provide a telescopic retractable door extension. Of course, the bridge platform 38 could also be provided with first and second retractable door extensions, each extending on a respective one of the side edges 44, 46 of the bridge platform 38.

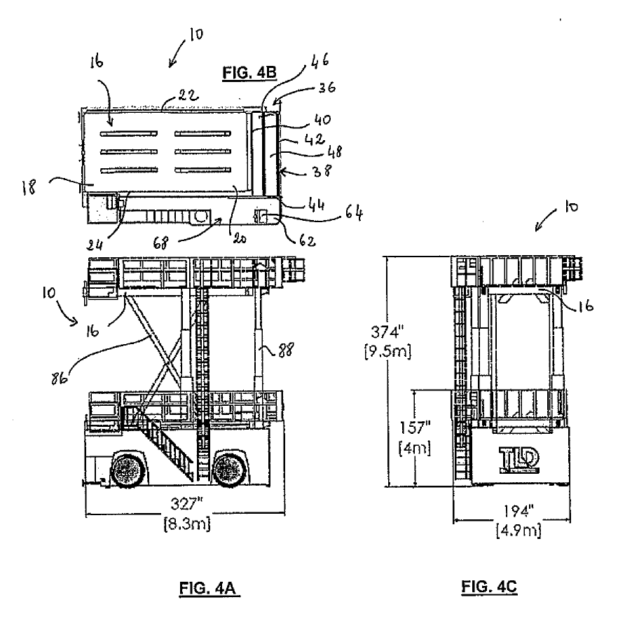

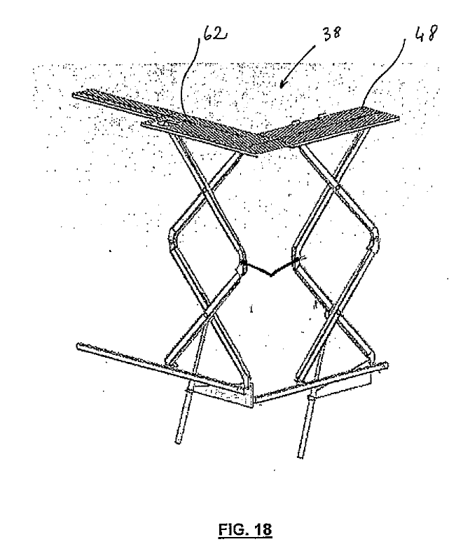

Referring again to FIGS. 3 and 4 and also to FIGS. 13A and 18, the bridge platform 38 further advantageously has an operating portion 62 extending in adjacent relationship sideways to the transfer portion 48. Moreover, the control means is advantageously provided with a control station 64 mounted on the operating portion 62 of the bridge platform 38 for operating each of the platforms 16, 38. This preferred configuration leaves a good vision of the loader parts and aircraft bay to the operator. Moreover, the operating portion 62 of the bridge platform 38 is preferably provided with operating portion handrails 66 surrounding the operating portion 62 for providing a protected working cell 68 to the loader operator working on the operating portion 62.

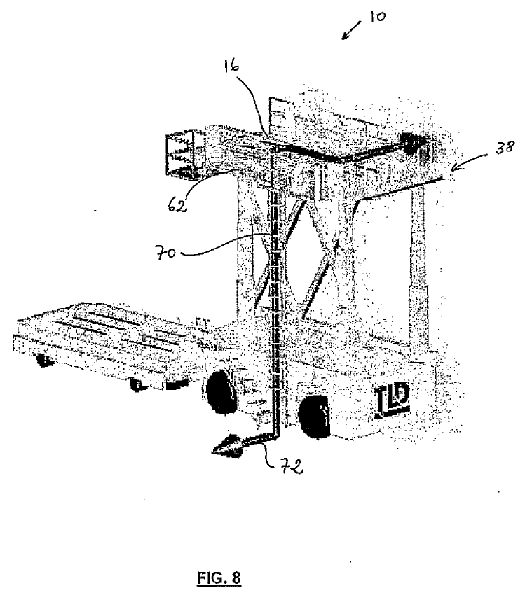

Referring now to FIG. 8, the bridge platform 38 is advantageously further provided with a ladder 70 attached to the operating portion 62 for providing a safe emergency path 72 accessible from the operating portion 62. Preferably the ladder 70 is a telescopic ladder. With this particular embodiment, the loader operator and the operators working inside the aircraft 28 can access to this ladder 70 in all time to quickly evacuate the aircraft 28 if needed, whatever the position of the loading platform 16.

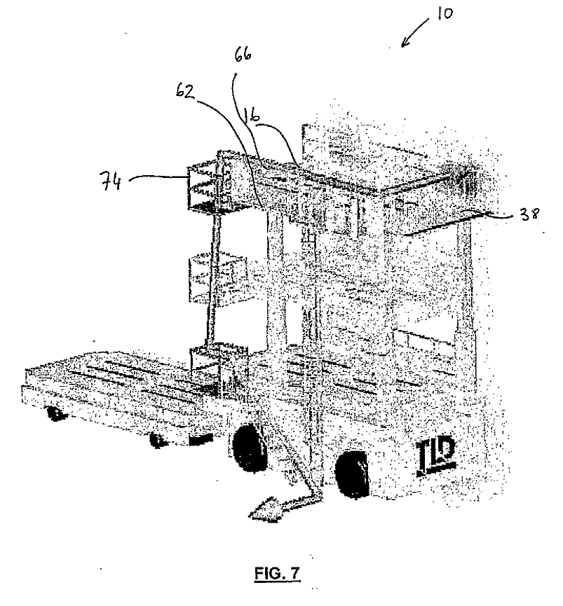

Referring now to FIG. 7, the loading platform 16 may advantageously be provided with a nacelle 74 attached thereto. When both the loading platform 16 and the bridge platform 38 extend at the same level, the nacelle 74 will advantageously extend in adjacent relationship with the operating portion 62 of the bridge platform 38 for providing to the aircraft operators a safe access to the aircraft 28 from the loader 10. Of course, the nacelle 74 and/or the handrails 66 extending around the operating portion 62 can be provided with a door for providing an easy access to the operators.

Referring again to FIGS. 1 to 3 and 5A to 5C, the aircraft loader of the present invention may advantageously be used with another platform connectable to the loading platform 16. Generally, the level of the aircraft upper deck extends at approximately 8 to 10 meters. Thus, the present aircraft loader 10 is advantageously used with an existing loading platform or another conventional aircraft loader, as can be seen on FIG. 6, to transfer the load from a first level to a second level, and then, from the second level to the upper deck. Such an arrangement is particularly advantageous since it allows to use existing materials currently in use to provide an effective solution.

Thus, according to a further preferred embodiment of the present invention, as illustrated in FIGS. 1 to 3 and 5A to 5C, the aircraft loader 10 has an additional chassis 76 connectable to the main chassis 12. The aircraft loader 10 also has a connecting device 78 mounted on the main chassis 12 proximate the loading end 18 of the loading platform 16 for pivotally connecting the additional chassis 76 to the main chassis 12. The aircraft loader 10 is also provided with an additional platform 80 mounted on the additional chassis 76. The additional platform 80 is moveable between a first elevation level and a second elevation level. The second level is comprised between the lower and upper elevation levels for allowing transfer of the goods between the additional platform 80 and the loading platform 16 when both the loading platform 16 and the additional platform 80 extend at a same level. The aircraft also has an additional lifting device 82, preferably a scissor-type mechanism, for raising and lowering the additional platform 80 between the first elevation level and the second elevation level. Preferably, the second elevation level extends at the lower elevation level. More preferably, the control means control operation of the additional lifting device 82.

In a further preferred embodiment, the aircraft loader 10 is further advantageously provided with a platforms coupling means (not shown) for removably coupling the loading platform 16 and the bridge platform 38 together when both platforms 16, 38 extend at a same level. Preferably, the coupling means has a first coupling device mounted on the loading platform 16 and a second coupling device mounted on the bridge platform 38. Each of the first and second coupling means advantageously cooperates with each other when both platforms 16, 38 extend at the same level. Thus, the first coupling device may be, for example, a rod lockable with the second coupling means. Preferably, the second coupling means is a passive device since the bridge platform 38 is unpowered. However, others arrangements could be envisaged.

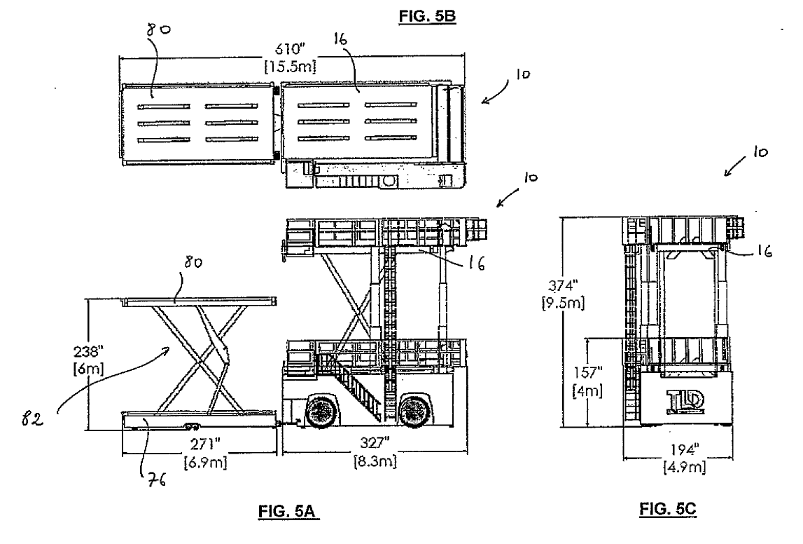

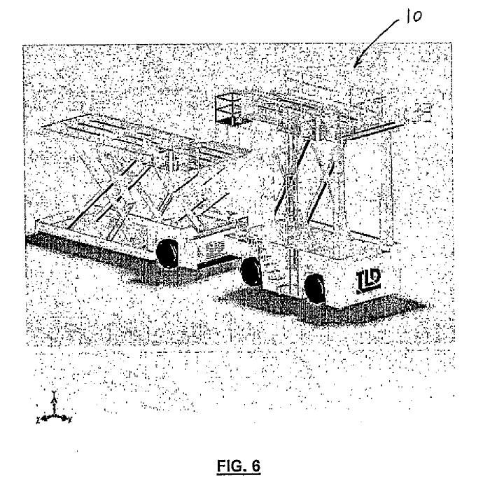

Referring now to FIGS. 5A to 5C and also to FIG. 9, in the case the aircraft loader 10 is provided with an additional loading platform 80, an additional coupling means 84 may advantageously be used for coupling the loading platform 16 to the additional platform 80. Preferably, the additional coupling means 84 will be of the same type of the platforms coupling means.

Referring again to FIGS. 1 to 4C, the lifting device 54 may advantageously be provided with a scissor-type mechanism 86 operatively connected between the chassis 12 and the loading platform 16. Moreover, the lifting device 54 is preferably further provided with a telescopic support mechanism 88 operatively connected between the chassis 12 and the interface device 36 for supporting the interface device 36 when the interface device 36 is raised. Thus, when both platforms 16, 38 extend in the lower position, the platforms 16, 38 are advantageously securely coupled together. The scissor-type mechanism 86 is operated for raising the loading platform 16. Since the bridge platform 38 is securely coupled to the loading platform 16, the bridge platform 38 is raised with the loading platform 16 until the desired height is reached. At this time, the telescopic support mechanism 88 supports the bridge platform 38 in its raised position. The bridge platform 38 can then be uncoupled from the loading platform 16. The loading platform 16 can then move independently for loading or unloading the aircraft since the interface device 36 stay in the raised position during the transfer of goods. When the transfer of goods is finished, the loading platform 16 is coupled again to the interface device 36 and the bridge platform 38 is lowered with the loading platform 16 with the help of the scissor-type mechanism 86. This embodiment is particularly advantageous since the interface device 36 has not to be powered. Of course others arrangement could be used.

In a further preferred embodiment, the interface device 36 is further provided with an interface device tilt mechanism (not shown) for tilting the bridge platform 38 in substantial alignment with the loading level 30 of the aircraft 28. This allows to align the attitude of the bridge platform 38 with the attitude of the loading level 30 of the aircraft 28 which is dependant on several parameters such as the repartition of the load in the aircraft for example. More preferably, the loading platform 16 is also provided with a loading platform tilt mechanism (not shown) for tilting the loading platform 16 in substantial alignment with the bridge platform 38 of the interface device 36, and consequently, with the loading level 30 of the aircraft 28. Thus, the loading platform 16, the bridge platform 38 and the aircraft level 30 extend at the same attitude, thereby facilitating transfer of loads therebetween. Even more preferably, as illustrated on FIG. 13A, each of the loading platform 16 and the bridge platform 38 is respectively provided with means 90 for facilitating displacement of the goods thereon, as well known in the art.

In a still further preferred embodiment of the present invention, the aircraft loader 10 may advantageously have a propulsion means for providing a self-propelled loader. A diesel engine may be mounted onto the chassis 12, preferably on the front section thereof. Alternatively, other types of engines, such as gasoline or electric engines may be used for propelling the loader 10.

Today, for most of the airports, 4 meters is the maximum available height around which airport roads are usually designed. Thus, the aircraft loader 10 preferably has a height of approximately 4 meters when the loading platform 16 and the bridge platform 38 are lowered in order to be usable in these airports. Similarly, for most airports, 12 meters is the maximum turning radius around which airport roads are usually designed for. Thus, in a preferred embodiment of the present aircraft loader 10, the additional chassis 76 and the connecting device 78 are particularly adapted to provide a turning radius of the aircraft loader of approximately 12 meters.

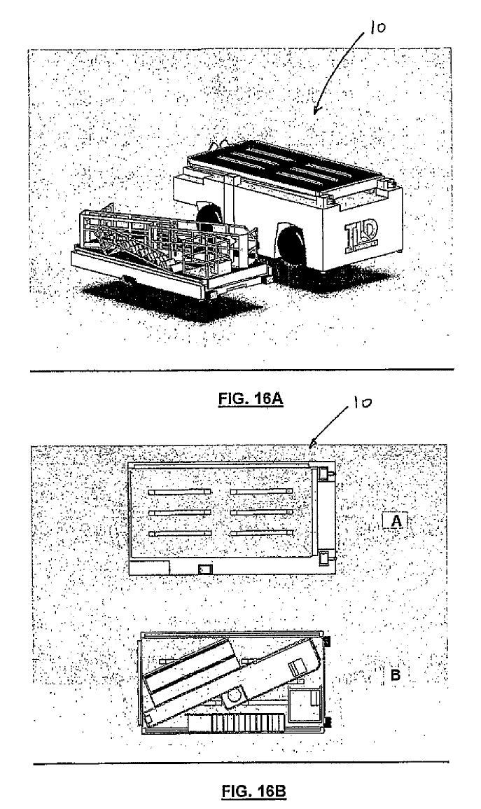

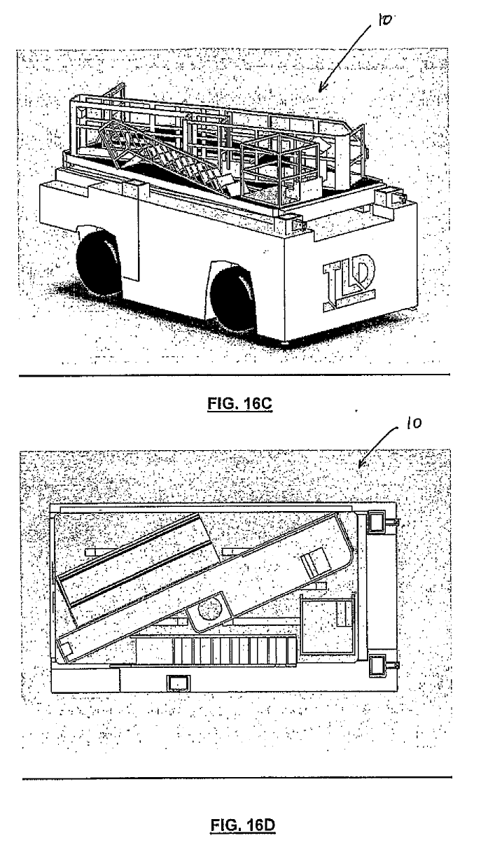

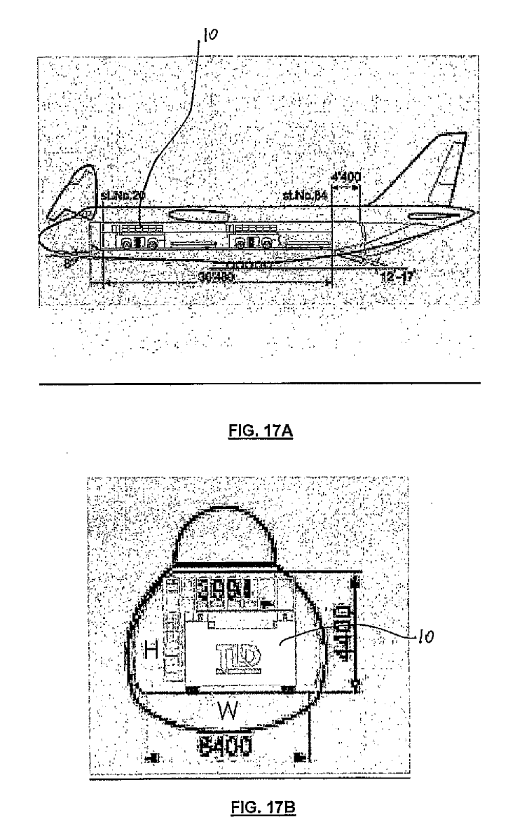

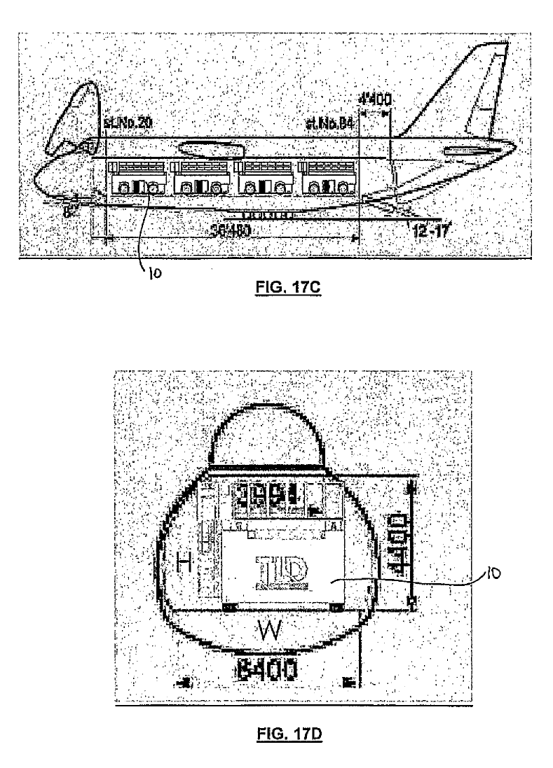

To provide an even more convenient aircraft loader, according to another aspect of the invention, there is provided an articulated aircraft loader for loading and unloading goods in and out of an aircraft having a loading level. This particular embodiment is advantageous since it provides a compact assembly more manoeuvrable and more transportable in an aircraft, as illustrated in FIGS. 16A to 17D. Moreover, thanks to its three dimension articulated design, the articulated aircraft loader is advantageously particularly well adapted to any landscape comprising viaducts or underpaths for example. Furthermore, the installation of the loader next to the aircraft is greatly simplified with regards to the prior art systems which are often time-consuming.

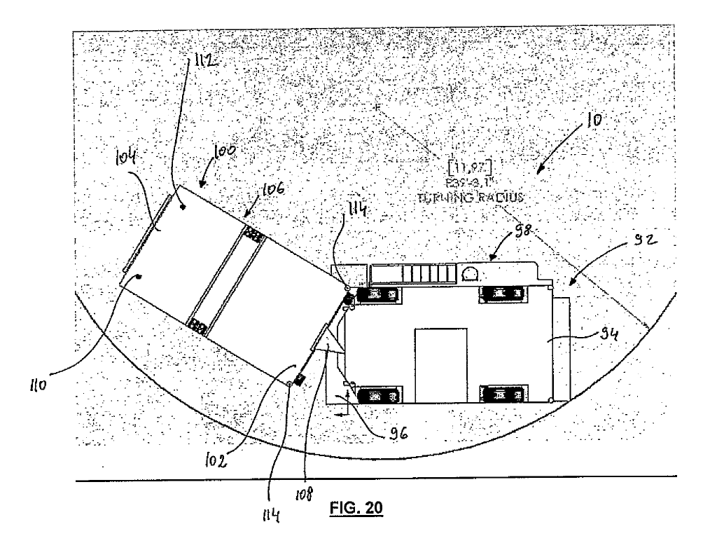

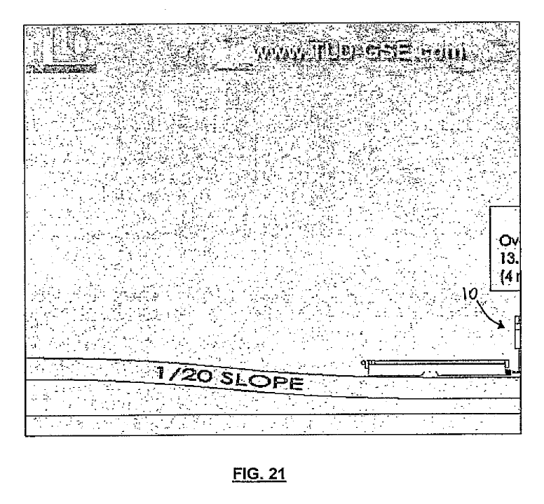

Referring now to FIG. 20, the articulated aircraft loader 10 has a main chassis 92 having a front end 94 opposite a rear end 96. The main chassis 92 is provided with a main loading platform 98 mounted thereon. The main loading platform 98 is moveable between a lower elevation level and an upper elevation level substantially coplanar with the loading level 30 of the aircraft 28. The articulated aircraft loader 10 also has a rear chassis 100 connectable to the main chassis 92. The rear chassis 100 has a front end 102 opposite a rear end 104. The rear chassis 100 is provided with a rear loading platform 106 moveable between a lowermost elevation level and a second elevation level comprised between the lower and upper elevation levels for allowing transfer of goods between the main and rear platforms 98, 106 when the platforms 98, 106 extend at a same level. The articulated aircraft loader 10 is also provided with articulated connecting means 108 operatively connected to each of the main chassis 92 and the rear chassis 100 for articularly connecting the rear chassis 100 to the main chassis 92. The articulated aircraft loader 10 also has straightening means operatively connected to the rear chassis 100 for straightening the rear chassis 100 in longitudinal alignment with the main chassis 92. In other words, in operation, the articulated aircraft loader 10 is moved closed to the aircraft for docking the main platform 98 to the aircraft level. With the systems of the prior art, several back and forward movements have to be made in order to bring the bulky loader in a correct alignment with the aircraft level since the available area on the tarmac is relatively limited, specially for big airplanes. These movements are time consuming. On the contrary, with the present invention, the main platform 98 is first aligned with the aircraft level. Once it has been done, the straightening means is activated to pivot the rear chassis 100 and its rear platform 106 in alignment with the main platform 98. This is particularly advantageous with respect to the prior art system, since the aircraft loader is easily and quickly installed without requiring extra labor time. Moreover, when the aircraft has been loaded, thanks to the straightening means, the rear chassis 100 can advantageously be pivoted again in its initial position to be easily driven away of the aircraft area without requiring extra manoeuvres.

In a preferred embodiment which is illustrated on FIG. 20, preferably, the straightening means has a motorised wheel 110 substantially transversally mounted under the rear chassis 100. More preferably, the straightening means further has a non-motorised wheel 112 substantially transversally mounted under the rear chassis 100. In this case, each of the wheels 110, 112 advantageously extends distal from each other on a arc of circle whose center extends at the connecting means 108. Also preferably, each of the wheels 110, 112 is oriented on this arc of circle. The motorised wheel 110 has a neutral position wherein the wheel is inactive. In this position, the aircraft loader 10 can be driven on the tarmac as usual. The motorised wheel 110 also has an operative position wherein the rear chassis 100 is sat on the motorised wheel 110 and also preferably on the non-motorised wheel 112. It is well known in the art that the chassis can be lowered with respect to its conventional wheels. Thus, in the operative position, the rear chassis 100 in lowered until its weight rests on the transversal wheels 110, 112. When the motorised wheel 110 is in the operative position, an operation thereof allows to pivot the rear chassis 100 with respect to the main chassis 92 around the articulated connecting means 108.

As illustrated on FIG. 20 and also on FIG. 1, preferably, the articulated connecting means 108 have a first connecting device mounted on the rear end 96 of the main chassis 92 and a second connecting device mounted on the front end 102 of the rear chassis 100. Each of the first and second connecting devices cooperates with each other. More preferably, the articulated connecting means 108 is adapted to provide a three-axis connection between each of the main and rear chassis 92, 100. This articulated connecting means 108 won't be described further since it is well known in the art. Indeed, any convenient means known in the art and providing this three-axis connection could advantageously be used.

As described above, the articulated aircraft loader 10 of the present invention also further advantageously has a platforms coupling means for removably coupling the main platform 98 and the rear platform 106 together when both platforms 98, 106 extend at a same level. The coupling means preferably has a first coupling device mounted on the main platform 98 and a second coupling device mounted on the rear platform 106, each of the first and second coupling means cooperating with each other when both platforms 98, 106 extend at the same level.

However, before coupling the platforms together, the attitude of each platform has to be monitored and corrected if necessary in order to prevent that the platforms knock together. This could arise when the ground is slightly inclined or when the aircraft level is inclined too.

To facilitate the alignment, the main loading platform is advantageously further provided with a main tilt mechanism (not shown) for tilting the main loading platform 98 in substantial alignment with the loading level of the aircraft. More advantageously, the rear loading platform 106 is also provided with a rear tilt mechanism for tilting the rear loading platform 106 in substantial alignment with the main loading platform 98. Thus, the level of the main platform 98 is firstly aligned with the level of the aircraft. Then, the level of the rear platform 106 is aligned with the level of the main platform 98. To facilitate the alignment, each of the main and rear chassis 92, 100 is advantageously respectively provided with lowerable stabilizing legs 114 projecting under the respective one of the chassis 92, 100. Preferably, each of these legs 114 can be independently controlled. To even more facilitate the alignment of each platform with respect to each other, the articulated aircraft loader 10 is advantageously further provided with an attitude monitoring means (not shown) mounted on one of the main and rear chassis 92, 100 for monitoring attitude of each of the platforms 98, 106. The attitude 10 monitoring means can be provided with a plurality of proximity detectors particularly arranged. Others arrangements using light transmitters and light receivers particularly combined could also advantageously be used. With this particularly advantageous preferred embodiment, a correction of the attitude of each platform 98, 106 in each axis can be done in a simple and automatic manner.

In another further preferred embodiment, as illustrated on FIG. 20, the front end 102 of the rear chassis 100 is adapted to move under the rear end 96 of the front chassis 92 when the articulated aircraft loader 10 rotatively move forwards. This arrangement allows to provide an even more compact assembly.

As explained above, in order to meet the dimension constraints imposed by the usual configuration of most airports, the connecting device is particularly adapted to provide a turning radius of the articulated aircraft loader of approximately 12 meters.

Also, as already mentioned above, in a still further preferred embodiment of the present invention, the articulated aircraft loader 10 may advantageously have a propulsion means for providing a self-propelled loader. A diesel engine may be mounted onto the chassis 92, preferably on the front section 94 thereof. Alternatively, other types of engines, such as gasoline or electric engines may be used for propelling the loader 10.

As it can be understood upon reading of the description of the present invention, the articulated loader of the present invention is particularly efficient for loading the upper deck of an aircraft in an easy, efficient and cost effective manner.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

What is claimed is:

1. An articulated aircraft loader for loading and unloading goods in and out of an aircraft having a loading level, said loader comprising:
a main chassis having a front end opposite a rear end, said main chassis being provided with a main loading platform mounted thereon, said main loading platform being moveable between a lower elevation level and an upper elevation level substantially coplanar with the loading level of the aircraft;
a rear chassis connectable to the main chassis, said rear chassis having a front end opposite a rear end, said rear chassis being provided with a rear loading platform moveable between a lowermost elevation level and a second elevation level comprised between the lower and upper elevation levels for allowing transfer of goods between said main and rear platforms when said platforms extend at a same level;
articulated connecting means operatively connected to each of said main chassis and said rear chassis for articularly connecting said rear chassis to said main chassis, said articulated connecting means being adapted to provide a swiveling connection around a vertical axis between each of said main and rear chassis; and
straightening means operatively connected to said rear chassis for straightening said rear chassis around the vertical axis in longitudinal alignment with said main chassis.

2. The articulated aircraft loader according to claim 1, wherein said straightening means comprise a motorised wheel substantially transversally mounted under the rear chassis, said motorised wheel having a neutral position wherein said wheel is inactive, and an operative position wherein said rear chassis is sat on said motorised wheel, an operation of said motorised wheel allowing to pivot the rear chassis with respect to the main chassis around the articulated connecting means when said motorised wheel is in said operative position.

3. The articulated aircraft loader according to claim 2, wherein said straightening means further comprise a non-motorised wheel substantially transversally mounted under the rear chassis, each of said wheels extending distal from each other on a arc of circle whose center extends at the connecting means.

4. The articulated aircraft loader according to claim 1, wherein said main loading platform is provided with a main tilt mechanism for tilting said main loading platform in substantial alignment with the loading level of the aircraft.

5. The articulated aircraft loader according to claim 4, wherein said rear loading platform is provided with a rear tilt mechanism for tilting said rear loading platform in substantial alignment with the main loading platform.

6. The articulated aircraft loader according to claim 5, further comprising an attitude monitoring means mounted on one of said main and rear chassis for monitoring attitude of each of said platform.

7. The articulated aircraft loader according to claim 6, wherein said attitude monitoring means comprises proximity detectors.

8. The articulated aircraft loader according to claim 1, wherein said articulated connecting means have a first connecting device mounted on said rear end of said main chassis and a second connecting device mounted on said front end of said rear chassis, each of said first and second connecting devices cooperating with each other.

9. The articulated aircraft loader according to claim 1, wherein said articulated connecting means is adapted to provide a three-axis connection between each of said main and rear chassis.

10. The articulated aircraft loader according to claim 1, wherein said front end of said rear chassis is adapted to move under the rear end of said front chassis when said articulated aircraft loader rotatively move forwards.

11. The articulated aircraft loader according to claim 1, further comprising a platforms coupling means for removably coupling said main platform and said rear platform together when both platforms extend at a same level.

12. The articulated aircraft loader according to claim 11, wherein said coupling means comprise a first coupling device mounted on said main platform and a second coupling device mounted on said rear platform, each of said first and second coupling means cooperating with each other when both platforms extend at the same level.

13. The articulated aircraft loader according to claim 1, wherein said upper elevation level is comprised between 8 and 10 meters.

14. The articulated aircraft loader according to claim 1, further comprising a propulsion means mounted to said main chassis for propelling said loader.

15. The articulated aircraft loader according to claim 1, wherein each of said main and rear chassis respectively comprises lowerable stabilizing legs projecting under the respective one of said chassis.

16. The articulated aircraft loader according to claim 1, wherein said connecting device is particularly adapted to provide a turning radius of said articulated aircraft loader of approximately 12 meters.
